(19) United States
(12) Patent Application Publication
(10) Pub. No.: US 2011/0275233 A1
(43) Pub. Date: Nov. 10, 2011

(54) Electrical cord lock protector apparatus

(76) Inventor: Terry Benear, Edmond, OK (US)

(21) Appl. No.: 13/068,197

(22) Filed: May 7, 2009

(51) Int. Cl. H01R 13/52; H01R 13/62

(52) U.S. Cl. 439/278; 439/369

(57) ABSTRACT

The present invention is for an electrical extension connection lock and protector. The designed hard casing surrounds the male and female ends of two cords where they abut and has a housing having a cavity therein with sufficient space to enclose the abutted ends, and having parallel apertures sized for electrical cords to pass out each end away from the protected connection point of the two electrical or electrical extension cords. An electrical cord gripping collar is positioned at each aperture opening, and soft material is used to seal the two halves of the protector when the hinge is closed, joining also the two halves of the parallel aperture collars, thus creating a sealed cavity. The soft aperture collar is formed of two semicircular matching junctures made of soft and pliable material having formed, when closed or joined, a smaller inside aperture through which the extension cord wire can pass, but is intended to press against all sides of the cord to create a water resistant seal. The casing halves, lined at its joining points by soft material, is made of any material hardness strong enough to hold form and protect the plugged ends of the cords, and when closed, to prevent the detachment of the extensions cords from each other.

### BACKGROUND OF THE INVENTION

The present invention is an electrical extension cord connector apparatus and method for securing the connection and locking the two cords to prevent accidental detachment, and from moisture. It was created 5 years prior to application by the inventor for the purposes and claims set forth above.

### BRIEF SUMMARY OF THE INVENTION

The present invention is for an electrical extension connection lock and protector. The designed hard casing surrounds the male and female ends of two cords where they abut and has a housing having a cavity therein with sufficient space to enclose the abutted ends, and having parallel apertures sized for electrical cords to pass out each end away from the protected connection point of the two electrical or electrical extension cords. An electrical cord gripping collar is positioned at each aperture opening, and soft material is used to seal the two halves of the protector when the case is closed, joining also the two halves of the parallel aperture collars, thus creating a sealed cavity. The soft aperture collar is formed of two semicircular matching junctures made of soft and pliable material having formed, when closed or joined, a smaller inside aperture through which the extension cord wire can pass, but is intended to press against all sides of the cord to create a water resistant seal. The casing halves, lined at its joining points by soft material, is made of any material hardness strong enough to hold form and protect the plugged ends of the cords, and when closed, to prevent the detachment of the extensions cords from each other.

### BRIEF SUMMARY OF VIEWS OF THE DRAWINGS

FIG. 1 is a perspective looking at the Cordlock closed with the closing latch facing the front.

FIG. 2 is a perspective looking at the Cordlock with both halves opened and seen from above.

FIG. 3 is a sectional view showing the aperture and the gripping collars.

FIG. 4 is a perspective showing the Cordlock in use, closed with extension cords enclosed and protected.

FIG. 5 is an exploded view showing the components of the invention with extension cords joined and lying within the cavity, and the protruding cords cradled in the aperture half on each end of one half of the Cordlock with the other half and the joints, hinges and sealing edges diagrammed.

### DETAIL, DESCRIPTION OF THE INVENTION

The present invention is for an electrical extension connection lock and protector. The designed hard casing surrounds the male and female ends of two cords where they abut and has a housing having a cavity therein with sufficient space to enclose the abutted ends, and having parallel apertures sized for electrical cords to pass out each end away from the protected connection point of the two electrical or electrical extension cords. An electrical cord gripping collar is positioned at each aperture opening, and soft material is used to seal the two halves of the protector when the hinge is closed, joining also the two halves of the parallel aperture collars, thus creating a sealed cavity. The soft aperture collar is formed of two semicircular matching junctures made of soft and pliable material having formed, when closed or joined, a smaller inside aperture through which the extension cord wire can pass, but is intended to press against all sides of the cord to create a water resistant seal. The casing halves, lined at its joining points by soft material, is made of any material hardness strong enough to hold form and protect the plugged ends of the cords, and when closed, to prevent the detachment of the extensions cords from each other.

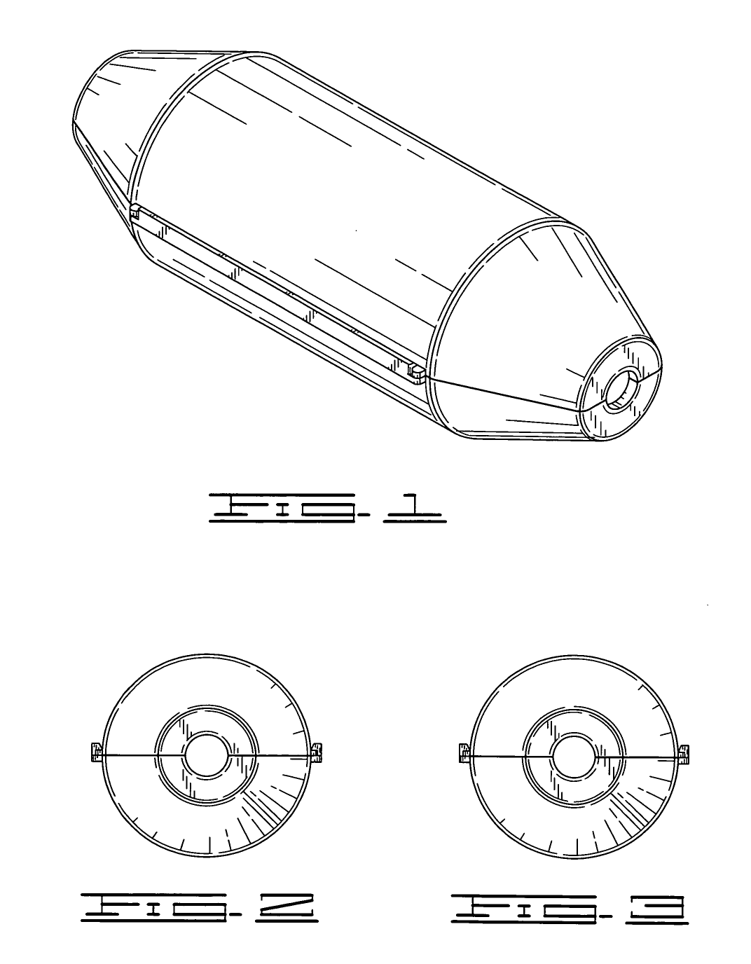

FIG. 1 shows the Cordlock in its intended use and as it appears after enclosing the joined extension cords. The Cordlock is closed by a latch shown in the center of FIG. 1 and the unseen ends of the extension cords are enclosed so that only the protruding wire cords are seen outside the housing or enclosure box. The seams are shown closed and sealed by the joining of the soft material lined edges of the frame of the housing.

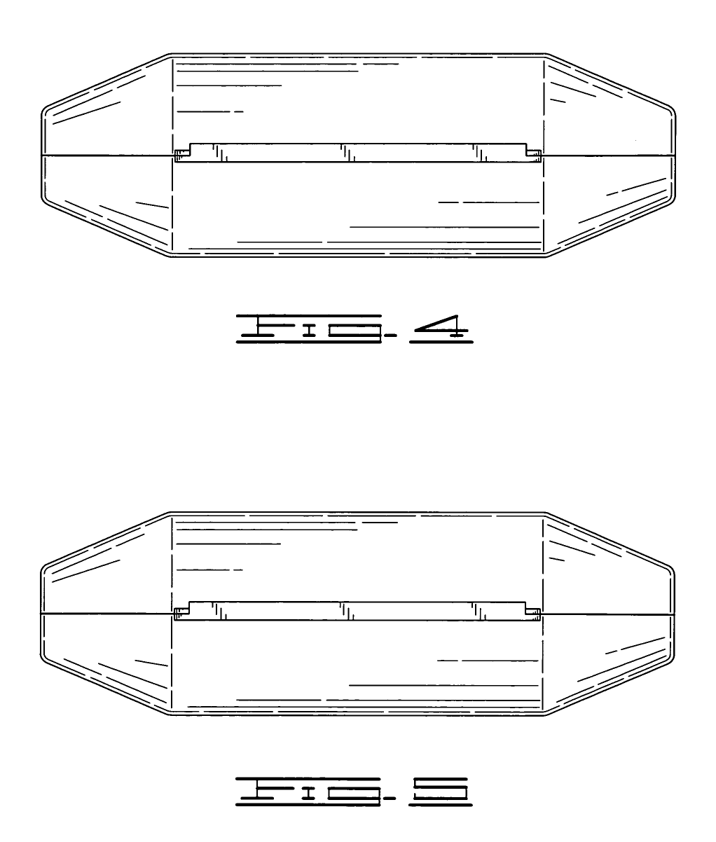

FIG. 2 shows the manner of placing the extension cords into the housing, with the cords being supported by - - - and then the cords are extended out each end of the housing so that the cord rests upon one half of the aperture lined with compression ring halves made of compressible soft material so as to seal the enclosure against the cords when the housing is closed.

FIG. 3 shows from the end the aperture and its structure and the embodiment of attaching or melding the soft compression material to the inner rim of the aperture structure of the housing.

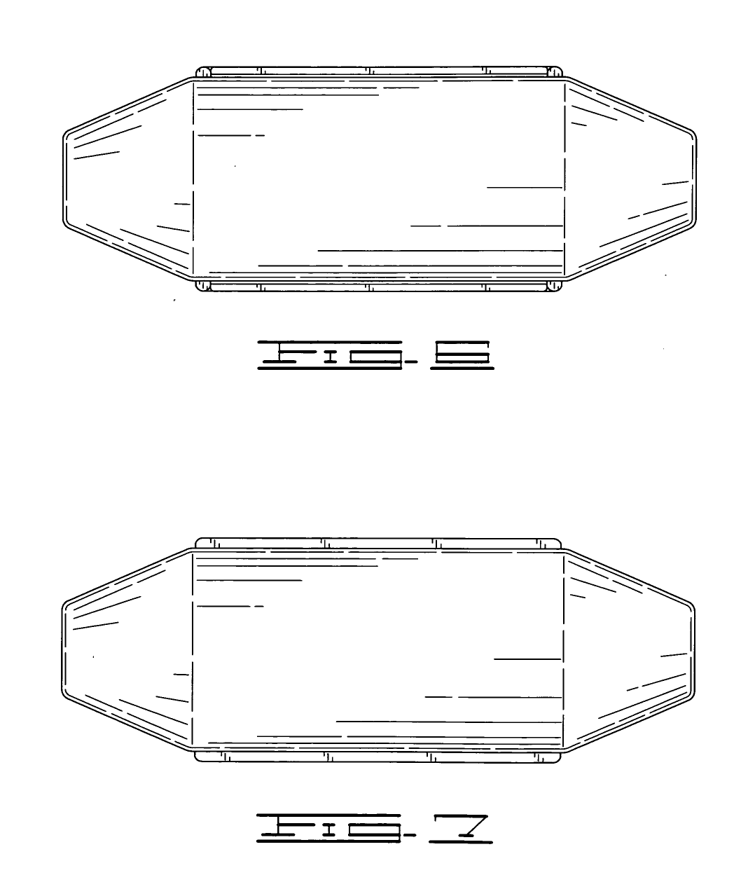

FIG. 4 illustrates the use of the features in FIGS. 2 and 3 after the housing is closed with the extension cords set inside.

FIG. 5 explodes the view of FIG. 4 showing the design of each component feature claimed in this application, and further explains the use of the Cordlock by means of illustration of its use in an exploded view.

1. An electrical cord connection housing, with hard casing surrounding the typical male and female ends of two cords where they abut and has a housing having a cavity therein with sufficient space to enclose the abutted ends.

2. The electrical extension cord connector housing set forth in claim 1 wherein at opposite ends there are soft gripping parallel apertures, and having parallel apertures sized for electrical cords to pass out each end away from the protected connection point of two cords.

3. The electrical extension cord apertures in claim 2, is lined on the outside edge, facing inside to the open aperture, with a soft aperture collar. This collar is formed of two semicircular soft and pliable materials having formed, when closed or joined, a smaller inside aperture through which the extension cord wire can pass, but is intended to press against all sides of the cord to create a water resistant seal.

4. The electrical extension cord connector set forth in claim 1 consists of hard casing halves, lined at its joining points by soft material, is made of any material hardness strong enough to hold form and protect the plugged ends of the cords, and when closed, to prevent the detachment of the extensions cords from each other.

5. The electrical extension cord connector set forth in claim 3 wherein the aperture in said casing uses two halves of a soft material that when joined, simulates a compression ring which is sized to create a seal whereby said each side of the aperture, joins when closing the housing and with an electrical extension cord is seated after the male and female ends are connected and centered in the housing, and the cord then passes through the central aperture formed by joining of said compressing ring and the extension cords passes through the opening so that the pressure formed keeps the cords from disengaging if there is any pulling or any further movement.

6. The electrical extension cord housing set forth in claims 1 and 5, wherein said housing is cylindrical or rectangular with sufficient internal space to hold the connected male and female ends of extension cords, is joined so that the matching halves meet are surfaced by a compressible soft material so as to form a water resistant barrier on the seams.

7. The electrical extension cord housing set forth in claims 1, 5, and 6 is closed with a latch that extends from one half and overlaps a portion of the second half and can be snapped closed by stressing the latch over an edge so that the latch presses back against that depression created for the protruding lip of the latch
